(19) United States
(12) Patent Application Publication
(10) Pub. No.: US 2008/0093890 A1
(43) Pub. Date: Apr. 24, 2008

(54) Component Having A Hard Foam Body And An Electric And/Or Electronic Functional Element

(75) Inventors: Walter Mehling, Veitshochheim (DE); Manfred Kittner, Albershofen (DE); Rolf Wagemann, Wurzburg (DE); Carstein Cilensek, Kumach (DE)

Correspondence Address: BLAKELY SOKOLOFF TAYLOR & ZAFMAN, 1279 OAKMEAD PARKWAY, SUNNYVALE, CA, 94085-4040, US

(73) Assignee: Intedis GmbH & Co. KG, Wurzburg (DE)

(21) Appl. No.: 11/573,599

(22) PCT Filed: Aug. 12, 2005
(86) PCT No.: PCT/DE05/01421

§ 371 Date: Aug. 6, 2007

(30) Foreign Application Priority Data
Aug. 13, 2004 (DE) 20 2004 020 378.2
Jan. 21, 2005 (DE) 10 2005 003 132.3

(51) Int. Cl. B60R 16/037; H01R 33/00

(52) U.S. Cl. 296/191; 439/660

(57) ABSTRACT

The present invention relates to a component (07, 25, 33), particularly for a vehicle (01), the component (07, 25, 33) being produced from a foamed polymer with formation of a hard foam body (11, 26, 36, 45, 52, 60, 66), and at least one electric and/or electronic functional element (10, 15, 16, 17, 18, 19, 20, 21, 35) being provided on the component (07, 25, 33, 50). A flat conductor set (08, 27, 34, 44, 51, 57, 67, 71) is provided for the electrically conductive contacting of the functional element (10, 15, 16, 17, 18, 19, 20, 21, 28, 35), in which at least two printed conductors (13) are attached jointly on or in an essentially planar and deformable insulator element (12, 30, 37), the flat conductor set (08, 27, 34, 44, 51, 57, 67, 71) being at least partially embedded in foam in the hard foam body (11, 26, 36, 45, 52, 60, 66).

The present invention relates to a component according to the preamble of claim 1.

Components of the generic type are used in particular, but in no way exclusively, in vehicle construction. For example, from vehicle construction paneling elements are known, in which the paneling is formed by a hard foam body, electric or electronic functional elements, such as illumination elements, being provided on the paneling. Components of the generic type may also be used as housing or sensor supports, however.

Typically, wiring harness sets are laid in the vehicle to connect the electric or electronic functional elements to the electric system of a vehicle and are contacted with plugs on the functional elements. A significant mounting outlay results due to the laying of the wiring harnesses in the vehicle. In addition, the electric or electronic functional elements may only be placed at those points which may be contacted in the event of concealed laying of the wiring harness.

Based on this prior art, it is therefore the object of the present invention to suggest a novel contacting concept for hard foam parts with electric functions.

This object is achieved by a component according to the teaching of Claim 1.

Advantageous embodiments of the present invention are the subject matter of the subclaims.

According to the present invention, flat conductor sets are used for the electrically conductive contact of the functional elements on the component. In these flat conductor sets, the printed conductors, such as photolithographically etched copper conductors or flat rolled copper conductors, are provided on an insulator element. The insulator element is used as a support and ensures electric insulation of the printed conductors on at least one side.

The flat conductor sets are distinguished by their deformability and their evenness at relatively low wall thickness. The component according to the present invention is based on the basic idea that such a flat conductor set is at least partially embedded in foam in the hard foam body during the production of the component. Therefore, the flat conductor set forms an integral part of the component, so that a separate attachment of the flat conductor set is no longer necessary. Rather, the flat conductor set may be fixed in a defined way by attaching the component in the vehicle. In addition, the components may be produced as pre-equipped functional modules, through which the final mounting of the vehicles is made significantly easier. Furthermore, the embedding of the flat conductor set in the hard foam body allows the placement of electric or electronic functional elements at installation locations which until now could be contacted with wiring harness sets not at all or only with great effort.

In order to anchor the flat conductor set reliably in the hard foam body, it is preferably to have recesses which may be penetrated by the hard foam.

In principle, it is conceivable that the electric or electronic functional element is contacted only after the flat conductor set has been embedded in foam. However, a higher processing reliability is achieved if the functional element is already attached to the flat conductor set, for example, soldered on. Therefore, the functional element may already be tested for correct function before being embedded in foam. Moreover, additional error sources, such as plug contacts for contacting the flat conductor set on the functional element, are precluded.

In order to fix the electric or electronic functional element securely on the component, it is especially advantageous if it is at least partially embedded in the foam of the hard foam body. A protection from undesired external influences, in particular from mechanical damage or moisture, may additionally be provided.

The flat conductor sets, which are planar in their starting forms, may be deformed according to a desired three-dimensional design before the embedding in foam and subsequently be embedded in this design. For this purpose, for example, the flat conductor set may be folded along at least one folding edge or twisted around at least one torsion axis or curved or bulged along at least one bending line. After curing of the hard foam, the three-dimensional design of the flat conductor set is fixed in the component, so that installation spaces which are otherwise difficult to use may be developed with electric and/or electronic functions easily.

The type of component which is produced using the technology according to the present invention is arbitrary in principle. For example, the production of housings for control units or similar items, for example, is conceivable.

The technology according to the present invention offers especially great advantages in the production of paneling elements, in particular for vehicle construction. For example, seat panels, door panels, sunroof panels, or roof lining elements may be produced using the technology according to the present invention by embedding flat conductor sets in foam in hard foam bodies.

In particular in paneling elements, a cover film is frequently provided on the visible side, in order to thus imitate the surface of a cowhide grain. This cover film may be used as a support, to which the flat conductor set is attached and subsequently has foam applied behind it.

The type of polymer which is used for producing the hard foam body is arbitrary in principle. However, electrically insulating polymers, particularly based on polyurethane, are preferably to be used, in order to avoid undesired short-circuits and/or leakage currents.

Insulating films may be used in particular as insulator elements, on which the printed conductors may be produced using photolithographic etching methods, for example, insulating films or this type may be equipped easily with electric and electronic components and thus form a circuit support.

If an electrically insulating polymer is used for foaming the hard foam body, the additional insulation on the side of the printed conductors facing away from the insulator film, such as a second insulator film, which is otherwise typical, may be dispensed with. The savings of such a second insulator film offers significant costs advantages, since the costs for flat conductor sets are decisively increased by the typically required insulation of the second surface, for example, by the application of the second insulator film.

Alternatively to insulating films, insulation sheaths may also be used as insulating elements. This insulation sheath encloses the printed conductors on all sides and is frequently used as a simple conductor element. By partially removing the insulation sheaths, however, equipping the flat conductor sets with electric and electronic components is also conceivable here, in order to again form a circuit support.

The components according to the present invention may be produced in principle using all types of flat conductor sets. However, FPCs (flexible printed circuits) or FFCs (flat flexible cables) are especially suitable, since these types of flat conductor sets have already proven themselves many times in vehicle construction.

There is no restriction in principle on the type of functional elements which may be contacted using the technology according to the present invention. According to a first preferred embodiment, the functional element is implemented as a lamp, in particular as an LED. As a result, entirely novel illumination concepts for the vehicle interior may be implemented by the technology according to the present invention when contacting lamps. Thus, for example, components, in particular seat panels, using which the foot space in a vehicle is illuminated, are conceivable. In addition, lights for illuminating internal mirrors, for example on sunscreens or on roof linings, may be implemented cost-effectively and effectively using the technology according to the present invention.

There are various concepts for the type of the attachment of the lamp to the component. According to a first alternative, the lamp is embedded together with the flat conductor set in the foam of the hard foam body. By embedding the lamp in foam, reliable protection of the lamp from external damage is ensured.

The lamp may preferably be situated on the surface of the component. The lamp is therefore not completely surrounded by foam, so that the light generated by the lamp is emitted directly at the surface. It is advantageous if the lamp is situated on the side of the component facing away from the visible side of the component. In this way, the lamp does not have to be covered on the visible side in a complex way. In particular to conduct the light generated by the lamp from the covered side of the component to the exterior side, in particular the visible side, a light guiding element may be used. The light guiding element preferably extends through the hard foam body.

According to an alternative embodiment, the lamp is situated in the interior of the hard foam body. In order to guide the light out of the interior of the hard foam body, a light guiding element is provided, using which the light generated by the lamp is relayed to a light exit opening.

As an alternative to embedding the lamp in foam, it is also conceivable that the flat conductor set has a cable tail projecting from the hard foam body, on which the lamp is situated. This projecting cable tail may be fixed on the component after the hard foam body cures, in order to thus implement the desired illumination function. It is preferable if the cable tail having the lamp provided thereon is fixed on a concealed surface of the component, so that the cable tail is not visible from the outside during usage of the component. In addition, a light guiding element is to be provided on the component with this type of attachment, using which the light generated by the lamp is relayed to a light exit opening.

Preferably, light guiding prisms or optical fibers may be used as light guiding elements, which are producible cost-effectively from plastic, for example.

Alternatively or additionally to the use of the lamp, a heating unit may also be provided on the component according to the present invention, which is electrically contacted using the flat conductor set. In particular, it is preferable if a film heater is integrated on the insulator element of the flat conductor set, so that embedding a separate heating unit in foam in addition to the flat conductor set is dispensed with.

If the component is implemented as a seat panel, heating units may thus be implemented for heating the knee area of the passengers on a rear bench seat.

In addition to lamps and heating units, sensors are also conceivable as electronic or electric functional elements in components according to the present invention. The sensors are preferably to operate contactlessly, so that they may be embedded completely in the hard foam body. Capacitive sensors are particularly suitable for this purpose, which detect changes in the capacitance in the electromagnetic environment, for example, when a body part approaches.

If the component is implemented as a set panel, the contact of the seat panel with body parts or objects may be detected by such sensors, in order to implement a pinch protector by analyzing the sensor signal.

Alternatively or additionally, sensors which are used as seat occupancy sensors are conceivable in the seat panel.

Using the technology according to the present invention, switches may also be integrated in foamed components. These switches are preferably also to operate contactlessly, in order to thus be able to be embedded completely in the hard foam body. Capacitively operating switches are especially suitable for this purpose.

In addition to directly usable functional elements, such as heating elements, lamps, sensors, or switches, upstream control and/or regulatory electronics may also be integrated into the hard foam part by use of the technology according to the present invention. Thus, for example, dimmable controls for light elements, temperature controls, or analysis circuits for analyzing sensor signals may be integrated on the flat conductor set and embedded in foam together with the flat conductor set in the hard foam part.

In order to be able to connect the flat conductor set in turn to the electric system of a vehicle, at least one end of the flat conductor set must be guided out of the hard foam body so it may be electrically contacted. There are various solution concepts for guiding the electric contact of the flat conductor set out of the hard foam body.

According to a first alternative, the flat conductor set itself is guided out of the hard foam body in a partition plane defined by the components of a foaming mold. In other words, this means that during the production of the hard foam body, the flat conductor set is laid in the foaming mold in such a way that the part to be guided out is guided out of the mold cavity in the partition plane between the two foaming mold halves. After the foaming of the mold cavity and the embedding of the flat conductor set in foam thus implemented, the hard foam part may be demolded, one end of the flat conductor set projecting out of the hard foam body. A suitable contacting element, such as a plug, may then be attached to the end of the flat conductor set which is guided out to contact the vehicle electric system.

Guiding out the flat conductor set in the partition plane has the disadvantage that the flat conductor set may not be guided out of the foam body at any arbitrary point of the component. In order to avoid this disadvantage, a seal element, in particular a seal stopper, may be embedded in foam in the outer surface of the hard foam body. This seal element has a bush, through which the flat conductor set is guided out of the interior of the hard foam body to the outside. The seal element is constructed in such a way that the foaming mold is sealed in a recess or depression during the foaming of the hard foam body. The following procedure is then used during the production of the component, for example.

The seal stopper is first attached to the flat conductor set and subsequently the flat conductor set, together with the seal stopper, is laid in the foaming mold. The seal stopper is attached in a recess or depression of the foaming mold in such a way that the flat conductor set is guided out of the interior of the mold cavity through the seal stopper into a recess or depression located outside the mold cavity. The mold cavity is subsequently foamed, the recess or depression being sealed off by the seal stopper, so that the polymer foam does not exit from the mold cavity. After the polymer foam is completely cured, the foaming mold is opened and the hard foam part is removed, the flat conductor set being guided through the seal stopper embedded in foam out of the hard foam body.

In order to be able to attach the seal element simply to the flat conductor set, it is preferably to be implemented in two parts. It is thus possible that by assembling the two parts of the seal element, the bush for guiding through the flat conductor set is formed. The two parts of the seal element are preferably to be separated from one another in a preferably planar partition line.

As an alternative to the plate-shaped seal elements, seal elements which are only partially embedded in foam are also conceivable, the seal element tapering at least slightly outward starting from the part embedded in foam. As a result, a type of seal stopper is thus formed which seals off the mold cavity of the foaming mold during foaming, because of the internal pressure rising in the interior of the mold cavity, without further measures.

Furthermore, a flange may be provided on the seal element, which is embedded in the foam body, to anchor the seal element.

As an alternative to the electric contact of the flat conductor set embedded in foam in the hard foam body, a plug may be attached to the flat conductor set. At least one plug element, such as a plug tab, is provided on this plug, using which a printed conductor of the flat conductor set may be electrically contacted.

It is especially advantageous if the plug is partially embedded in foam in the hard foam body. Thus, without further measures, the electric contact element is guided out of the hard foam body by the plug elements provided on the plug.

If the plug is embedded in foam of the hard foam body, it is preferably to have a rounded outer contour, since rounded outer contours of this type make sealing the sealing line between the inner wall of the foaming mold and the plug easier. In order to also implement a seal effective against higher internal pressures, the plug is to have a closed peripheral sealing surface, which comes to rest against the interior of the foaming mold during the foaming of the hard foam body by forming a sealing line and seals the mold cavity of the foaming mold. This sealing surface is preferably also to have a rounded outer contour.

The way in which the sealing surface for sealing the sealing line between plug and foaming mold is implemented is arbitrary in principle. Sealing rings, such as elastomer rings, which ar attached to the plug may preferably be used for this purpose. The peripheral sealing surface is to run a plane, namely a sealing plane. This sealing plane running through the plug body separates the foamed area from the foam-free areas. The plug elements of the plug penetrate the sealing plane to thus implement the electric contact between the non-foamed ends and the ends contacted on the flat conductor set. For this purpose, the plug elements of the plug are preferably to be bent in steps.

Various embodiments of the present invention are schematically illustrated in the drawing and explained in greater detail for exemplary purposes in the following.

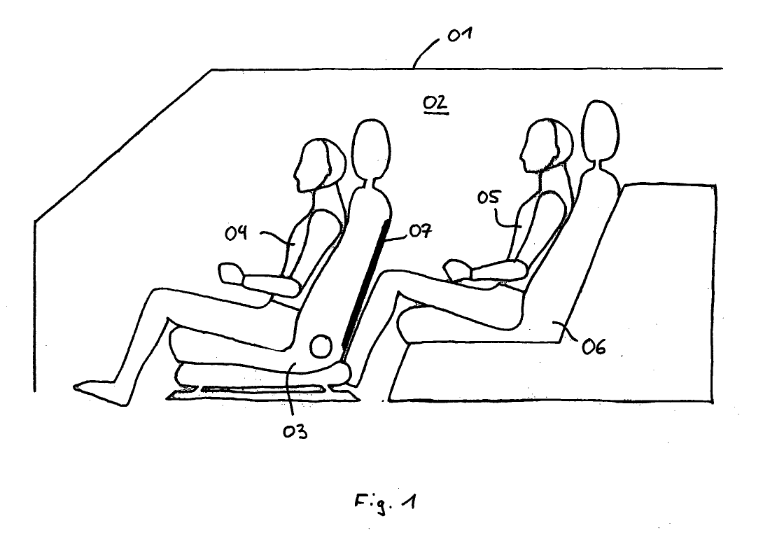

FIG. 1 shows the vehicle interior of a vehicle in a schematic cross-section;

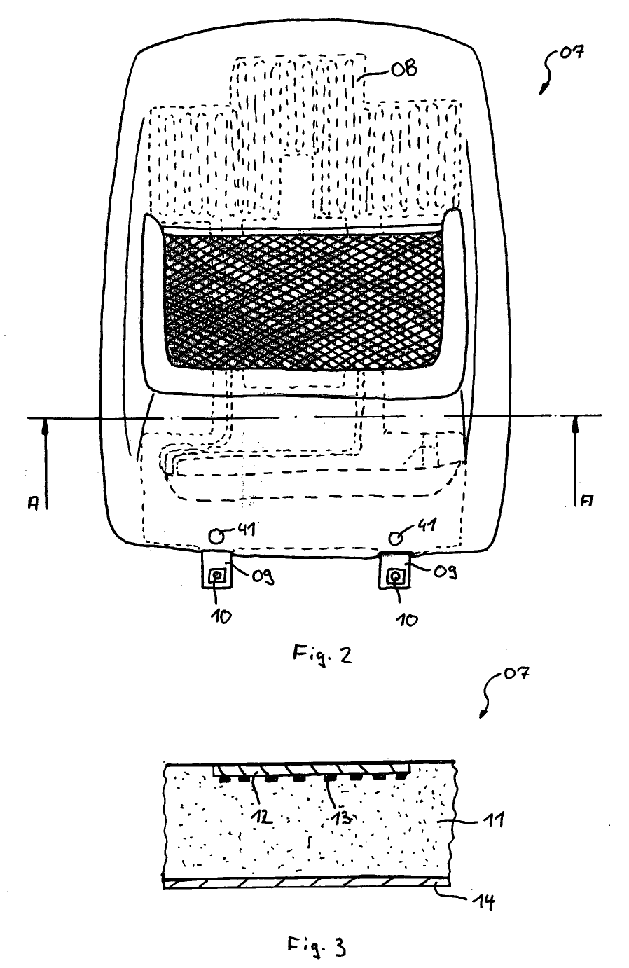

FIG. 2 shows the seat panel of the vehicle seat in the vehicle interior from FIG. 1 in a view from the rear visible side;

FIG. 3 shows the seat panel from FIG. 2 in partial cross-section along section line A-A;

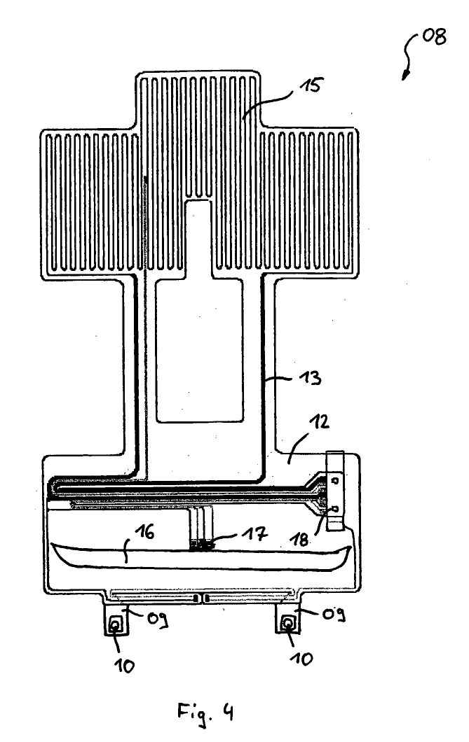

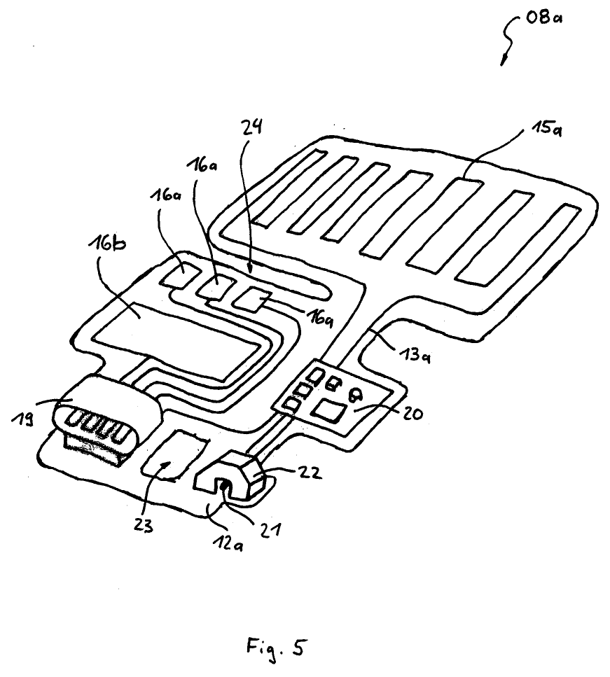

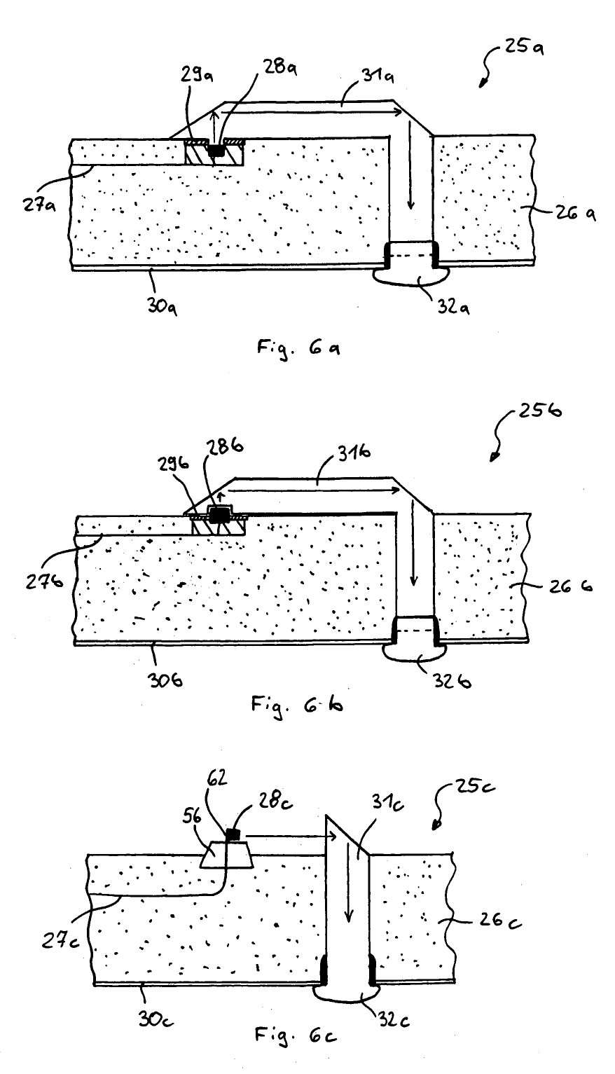

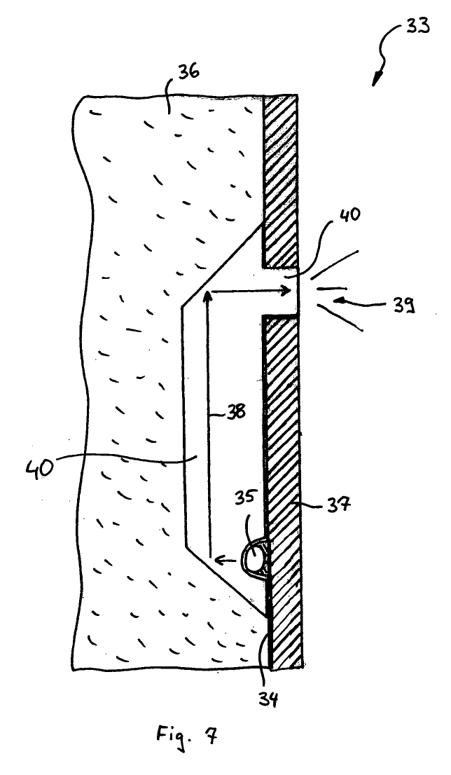

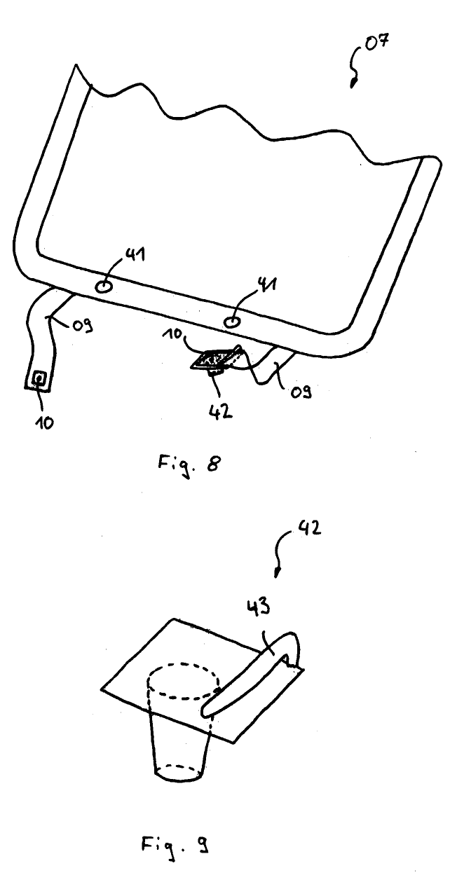

FIG. 4 shows the flat conductor set embedded in foam in the panel part from FIG. 2 in a view from above;

FIG. 5 shows a second embodiment of a flat conductor set which may be embedded in foam in a seat panel in a perspective view from above;

FIG. 6a shows a first embodiment of a component according to the present invention having a lamp in partial cross-section;

FIG. 6b shows a second embodiment of a component according to the present invention having a lamp in partial cross-section;

FIG. 6c shows a third embodiment of a component according to the present invention having a lamp in partial cross-section;

FIG. 7 shows an embodiment of a component according to the present invention having a lamp embedded in foam in partial cross-section;

FIG. 8 shows the component from FIG. 2 having an attached light guiding element in a perspective view;

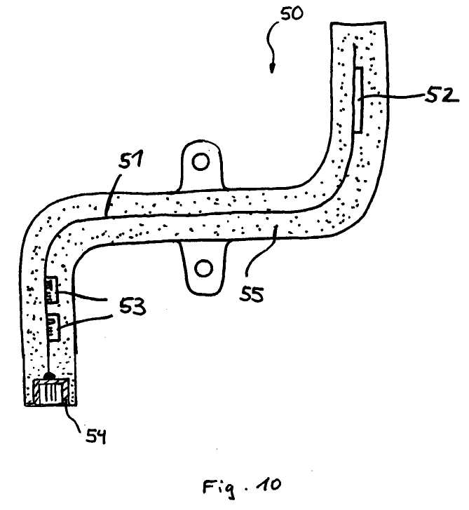

FIG. 9 shows a light guiding element to be situated on the component in a perspective view;

FIG. 10 shows a multiply curved component having flat conductor set embedded in foam in cross-section;

FIG. 11 shows a foaming mold for producing a component according to the present invention in cross-section;

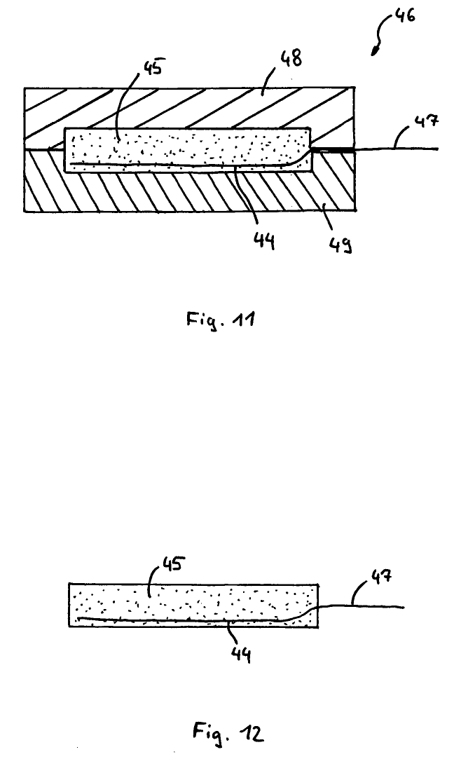

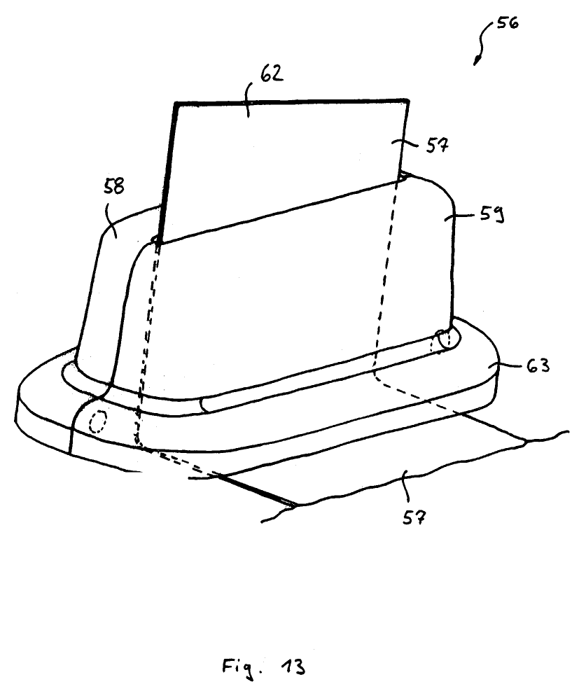

FIG. 12 shows the component produced in the foaming mold from FIG. 10 in cross-section;

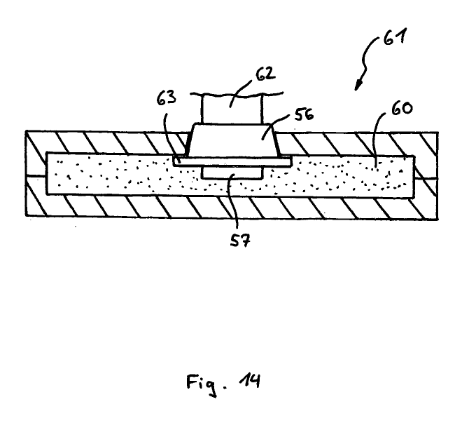

FIG. 13 shows a seal element to be embedded in foam in a component according to the present invention in a perspective view;

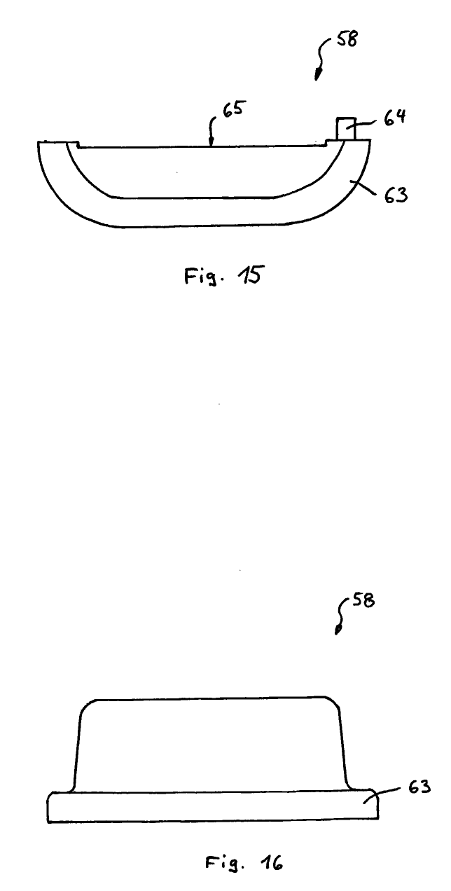

FIG. 14 shows a foaming mold for producing a component according to the present invention using a seal element form FIG. 13 in cross-section;

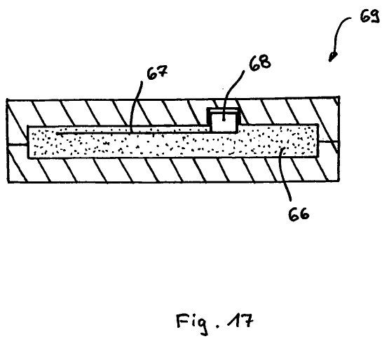

FIG. 15 shows a half of the seal element from FIG. 13 in a view from above;

FIG. 16 shows the half from FIG. 15 in a lateral view;

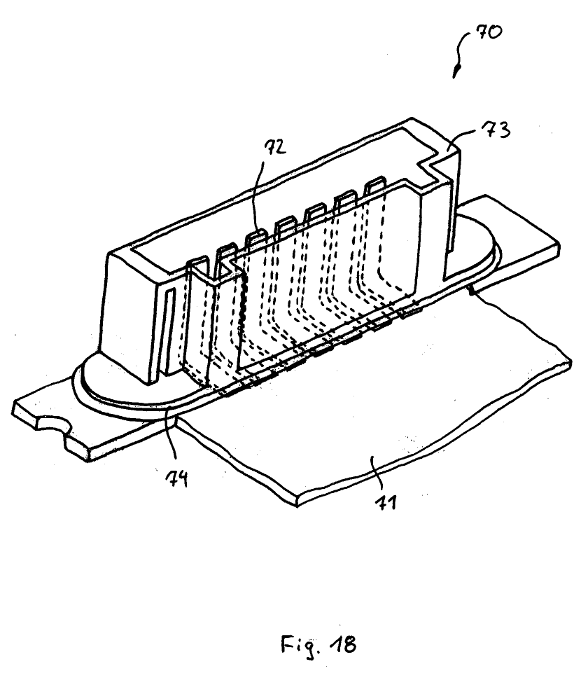

FIG. 17 shows a foaming mold for producing a component according to the present invention having a foamed plug in a schematic cross-section;

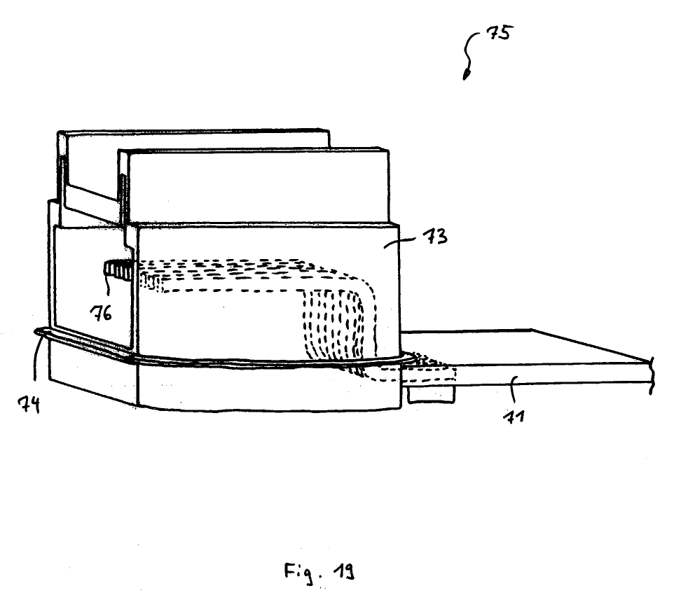

FIG. 18 shows a first embodiment of a plug for producing a component according to the present invention in a perspective view;

FIG. 19 shows a second embodiment of a plug for producing a component according to the present invention in a perspective view;

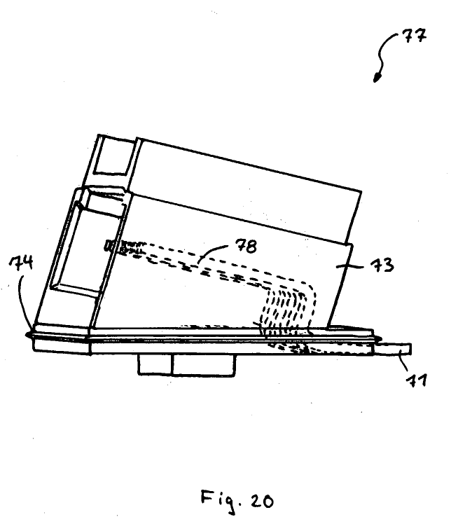

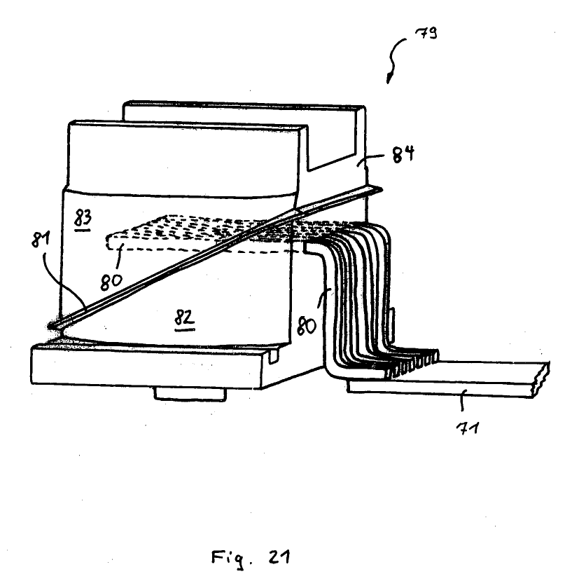

FIG. 20 shows a third embodiment of a plug for producing a component according to the present invention in a perspective view;

FIG. 21 shows a fourth embodiment of a plug for producing a component according to the present invention in a perspective view.

FIG. 1 shows a vehicle 01 having a vehicle interior 02 in a schematic cross-section. A driver seat 03 is provided in the vehicle interior 02, on which a driver 04 may be seated. On the side of the driver seat 03 pointing toward the passengers 05 on the rear bench set 06, a component 07 according to the present invention, implemented like a seat panel, is attached to the driver seat 03. The component 07 comprises a hard foam body 11, in which a flat conductor set 08 for contacting various electric and/or electronic functional elements is embedded in foam.

FIG. 2 shows the component 07 in a schematic view from the rear visible side. A luggage net is attached to the visible side of the component 07.

The flat conductor set 08, indicated by dashed lines, is embedded in foam in the interior of the component 07. The flat conductor set 08 has two cable tails 09 projecting out of the hard foam body 11, to each of which a lamp 10, specifically an LED, is attached. The mode of operation and type of attachment of the lamps 10 are explained in greater detail in the following on the basis of the description of FIG. 8 and FIG. 9.

FIG. 3 shows the construction of the component 07 in cross-section. The flat conductor set 08, which is formed by an insulator film 12 and flat printed conductors 13 etched photolithographically thereon, is embedded in foam in the surface of the hard foam body 11 of the component 07. Because of the elastic deformability of the flat conductor set 08, it may be shaped unrestrictedly to the predefined outer contours of the component 07 during foaming of the hard foam body 11, in particular bent, bulged, folded, or twisted.

The insulator film 12 is situated in the hard foam body 11 in such a way that the flat printed conductors 13 point into the interior of the hard foam body 11, which is foamed from an electrically insulating polymer, such as polyurethane. An additional electric insulation of the flat printed conductors 13 may thus be dispensed with, since the insulation of the flat printed conductors is implemented by the hard foam body 11. A cover film 14 is attached to the exterior of the hard foam body 11 during production of the component 07, for example has foam applied from behind, laminated on, or glued on, in order to thus form a visually appealing visible side, for example, having a grain surface.

FIG. 4 shows the construction of the flat conductor set 08 in a view from above. The flat conductor set 08 comprises the two cable tails 09 having the lamps 10 attached thereto. In addition, a heating unit 15 implemented as a film heater is provided on the flat conductor set 08, using which the component 07 acting as a seat panel may be heated in the area of the knee of the passengers 05.

A contactless, capacitive sensor 16 is provided at the lower end of the flat conductor set 07, using which the contact of body parts or objects on the external surface of the component 07 may be detected to implement a pinch protector. As soon as the sensor 16 communicates the contact of a body part or object with a control unit 17, which is also attached to the flat conductor set 08, the further seat adjustment of the driver seat 03 is automatically blocked, in order to prevent pinching of the legs of passengers 05 and/or of objects located in the foot space behind the driver seat 03 (see FIG. 1). Temperature control electronics 18 are attached to the flat conductor set 08 to activate the heating unit 15. The plug for connecting the flat conductor set to the electric system of the vehicle 01 is not shown in FIG. 4.

An alternative embodiment 08a of a flat conductor set to be embedded in foam in the component 07 is shown in FIG. 5. A plug 19 for connecting the flat conductor set 08a to the electric system of the vehicle 01 may be seen. Furthermore, the flat conductor set 08a has capacitive sensor surfaces 16a and 16b, a heating unit 15a, control and regulatory electronics 20, and a lamp, specifically an LED 21, whose light is deflected by a light guiding element 22. Recesses 23 and slots 24 are provided in the insulator film 12a, in order to anchor the flat conductor set 08a optimally as it is embedded in the foam of the hard foam body 11.

FIG. 6a shows an embodiment 25a of a component according to the present invention, in whose hard foam body 26a a flat conductor set 27a having a lamp 28a attached thereto is embedded in foam. The lamp 28a is situated on the surface of the hard foam body 26a which does not form the visible side of the component 25a. An adhesive ring 29a, which adheres on both sides, using which the housing ring of the lamp 28a is attached to the interior of a foaming mold, is used for the correct positioning of the lamp 28a.

A cover film 30a is situated on the visible side of the component 25a. A light guiding element 31a implemented as a deflection prism is used to guide the light generated by the lamp 28a through the hard foam body 26a and the cover film 30a. A transparent cover element 32a is placed on the light exit opening in the cover film 30a from the visible side to cover the edge of the recess.

FIG. 6b shows a second embodiment 25b of a component according to the present invention, whose construction essentially corresponds to the embodiment 25a. However, the lamp 28b projects beyond the surface of the hard foam body, so that the generated light may be coupled better into the light guiding element 31b. A depression for receiving the projecting part of the lamp 28b is provided in the foaming mold provided for this purpose to produce the embodiment 25b. An adhesive ring 29b which adheres on both sides is again used to fix the lamp 28b in the depression of the foaming mold. As an alternative to the adhesive ring 29b, the flat conductor set 27a may also be glued from behind using an adhesive strip in the area of the lamp 28b and may thus be fixed on the inner wall of the foaming mold.

In the embodiment 25c shown in FIG. 6c, the flat conductor set 27c is guided out of the hard foam body using a seal element 56, which is described in greater detail below, while forming a cable tail 62. The lamp 28c is attached to the cable tail 62. The lamp 28c lies opposite the light guiding element 31c plugged through the hard foam element 26c from the visible side, whose front part is simultaneously used as the cover element 32c. The light generated by the lamp 28c may thus be coupled into the light guiding element 31c and guided through the hard foam body 26c and the cover film 30c to the visible side of the component 25.

FIG. 7 shows a further embodiment 33 of a component according to the present invention in cross-section. During the production of the component 33, a flat conductor set 34 having a lamp 35 attached thereto, specifically an LED, is attached to a cover film 37 forming the visible side of the component, for example glued on, and subsequently has the foam of a hard foam body 36 applied behind it. The lamp 35 is situated on the side pointing into the interior of the hard foam body 36. In order to be able to relay the light generated by the lamp 35, which is indicated in FIG. 7 by light beams 38, to a light exit opening 39, a light guiding element 40 is embedded in foam in the hard foam body 36 together with the flat conductor set 34. The light guiding element 40 is implemented as a light guiding prism, so that the light beam 38 may be deflected in the direction of the light exit opening 39 on the prism surfaces of the light guiding element 40.

FIG. 8 shows the component 07 having the cable tails 09 and the lamps 10 attached thereto once again in a perspective view. Two recesses 41 are provided on the lower edge of the component 07, into which two light guiding elements 42 may be plugged. The light guiding elements 42 comprise a transparent plastic body and are plugged onto the cable tails 09 above the lamps 10 using a clamp 43. By plugging the light guiding elements 42 into the recesses 41, the light generated by the lamps 10 may be guided through the component 07 from the cover side to the exterior side.

FIG. 9 shows the light guiding element 42 having the clamp 43 in a perspective view.

FIG. 10 shows a three-dimensionally molded component 50 in cross-section. The flat conductor set 51 embedded in foam in a hard foam body 55 is bent multiple times in accordance with the three-dimensional shape of the component 50. A contactless capacitive sensor 52 and the electronic components 53 of a control and analysis unit are attached to the flat conductor set 51. A plug 54 for connecting the flat conductor set 52 to a vehicle electric system is provided on one end of the flat conductor set 51. The plug 54 is embedded in foam together with the flat conductor set 52 in the hard foam body 55. Two attachment eyes are shaped on laterally in one piece on the hard foam body 55.

FIG. 11 and FIG. 12 represent a first possibility for guiding out a flat conductor set 44 from the hard foam body 45 of a component according to the present invention. For this purpose, the flat conductor set 44 is inserted in a foaming mold 46 and a projecting cable tail 47 is guided out in the partition plane between the two foaming mold parts 48 and 49. Subsequently, the two foaming mold parts 48 and 49 are closed and the mold cavity thus resulting is foamed with the hard foam body 45. After the hard foam body 45 is demolded, the cable tail 47 of the flat conductor set 44 projects beyond the hard foam body 45 (see FIG. 12).

FIG. 13 shows an alternative possibility for guiding out the electric contact of a flat conductor set 57 from a foamed hard foam body. For this purpose, a seal element 56, which is formed in two parts by two disk-shaped seal parts 58 and 59, is embedded in foam together with the flat conductor set 57 in a hard foam body 60 (see FIG. 14). The seal parts 58 and 59 are plugged together while enclosing the flat conductor set 57 and seal off the foaming mold 61 during the foaming of the hard foam body 60 in a recess provided for this purpose.

FIG. 14 schematically illustrates the production of a hard foam body 60 in a foaming mold 61 using a seal element 56. The projecting cable tail 62 of the flat conductor set 57 is guided out to the outside through the seal element 56 from the interior of the foaming mold 61, the seal element 56 sealing the foaming mold 61 like a seal stopper because of its shape, which tapers upward. For better anchoring of the seal element 56 in the hard foam body 60, a flange 63 is molded onto the bottom of the seal element 56.

FIG. 15 and FIG. 16 show the seal part 58 in a view from above and in a lateral view, respectively. As may be seen from FIG. 15, projections 64 are molded onto the seal part 58 and, having a complementary function, on the seal part 59, using which the seal parts 58 and 59 may be plugged together. A flat depression 65 is provided on the inner faces of the seal parts 58 and 59, in which the flat conductor set 57 is received.

The production of a hard foam body 66 having flat conductor set 67 embedded in foam and a plug 68 attached thereto is schematically illustrated in FIG. 17. During foaming of the hard body 66 in the foaming mold 69, the plug 68 is laid in a depression 65, so that the depression 65 is sealed by the plug 68. The foaming over the contact surfaces on the plug 68 is thus prevented.

FIG. 18 shows a first embodiment 70 of a plug, which may be embedded in foam in a hard foam body together with a flat conductor set 71. The flat printed conductors (not shown in FIG. 18) on the flat conductor set 71 are each contacted with plug elements 72. The plug elements 72 are implemented like plug tabs, which are produced as bent sheet metal parts and may be inserted into the plastic body 73 of the plug 70.

In order to prevent foaming over the contact surfaces on the plug elements 72 during the production of the hard foam body, a peripheral sealing surface 74 is provided on the plug 70, which comes to rest on the interior of the foaming mold to form a seal. The sealing surface 74 has no corners or edges, but rather forms a rounded outer contour, to ensure an optimal seal of the sealing line between plug 70 and foaming mold. A sealing ring, such as a rubber sealing ring, may be situated in the sealing surface 74. As an alternative, another sealing element may also be injected on using a two-component material. The plug elements 72 extend perpendicularly to the external surface of the hard foam part, so that the counter plug may be plugged from above onto the plug 70.

FIG. 19 shows a second embodiment 75 of a possible plug for contacting on a flat conductor set 71. The plug elements 76 extend parallel to the external surface of the hard foam part. In order to nonetheless be able to contact them easily on the flat conductor set 71, the plug elements 76 are bent in steps.

FIG. 20 shows a third embodiment 77 of a plug for contacting on a flat conductor set 71 which is embedded in foam. The plug elements 78 of the plug 77 extend diagonally to the external surface of the hard foam body, so that the counter plug may be plugged on diagonally from above.

FIG. 21 shows a fourth embodiment 79 of a plug which may be contacted on a flat conductor set 71 embedded in foam. In the plug 79, the contact surfaces of the plug elements 80 again extend parallel to the external surface of the hard foam body. A sealing surface 81 running diagonally to the external surface of the hard foam body is used to seal the plug 79 in the foaming mold. The sealing surface 81 runs in a sealing plane extending diagonally to the external surface of the hard foam body, so that the part 82 of the plug 79 lying diagonally below the sealing surface 81 is embedded in foam, and the part 83 of the plug 79 lying diagonally above the sealing surface is not embedded in foam. This type of plug construction allows the plug elements 80 to be mounted easily on the plastic body 84 of the plug 79 by insertion.

1. A component (07, 25, 33, 50), particularly for a vehicle (01), the component (07, 25, 33, 50) being produced from a foamed polymer with formation of a hard foam body (11, 26, 36, 45, 55, 60, 66), and at least one electric and/or electronic functional element (10, 15, 16, 17, 18, 19, 20, 21, 35, 52, 53) being provided on the component (07, 25, 33, 50),
characterized in that
a flat conductor set (08, 27, 34, 44, 51,57, 67, 71) is provided for the electrically conductive contacting of the functional element (10, 15, 16, 17, 18, 19, 20, 21, 28, 35, 52, 53), in which at least two printed conductors (13) are attached jointly on or in an essentially planar and deformable insulator element (12, 30, 37), the flat conductor set (08, 27, 34, 44, 51, 57, 67, 71) being at least partially embedded in foam in the hard foam body (11, 26, 36, 45, 50, 60, 66).

2. The component according to claim 1,
characterized in that
the flat conductor set (08a) has recesses (23) and/or slots (24), which are penetrated by foam during formation of the hard foam body (11).

3. The component according to claim 1,
characterized in that
the electric and/or electronic functional element (10, 15, 16, 17, 18, 19, 20, 21 28, 35) is attached to the flat conductor set (08, 27, 34, 44, 57, 67, 71), particularly soldered on.

4. The component according to claim 1,
characterized in that
the electric and/or electronic functional element (10, 15, 16, 17, 18, 19, 20, 21 28, 35, 52, 53) is at least partially embedded in foam in the hard foam body (11, 26, 36, 45, 50, 60, 66).

5. The component according to claim 1,
characterized in that
the flat conductor set (51) is deformed to form a three-dimensional shape, in particular folded along at least one folding edge or twisted around at least one axis of torsion or bent or bulged along at least on e bending line, and together with the deformed part is embedded in foam in the component (50).

6. The component according to claim 1,
characterized in that
the component is implemented as a housing.

7. The component according to claim 1,
characterized in that
the component (7) is implemented as a paneling element, in particular a set panel, a door panel, a sunroof panel, a trunk panel, a cockpit panel, a dashboard support, or a roof lining element.

8. The component according to claim 1,
characterized in that
the component (07, 25, 33) has a cover film (14, 30, 37), particularly on the visible side of a paneling element.

9. The component according to claim 8,
characterized in that
the flat conductor set (34) is attached to the cover film (37) and particularly together with the cover film (37) has foam applied behind to form the hard foam body (36).

10. The component according to claim 1,
characterized in that
the hard foam body (11, 26, 36, 45, 60, 66) is foamed from an electrically insulating polymer, in particular based on polyurethane.

11. The component according to claim 1,
characterized in that
the insulator element is implemented as an insulator film (12, 30, 37).

12. The component according to claim 11,
characterized in that
no additional cover for insulating the printed conductors (13), in particular no second insulator film, is provided on the side of the printed conductors (13) facing away from the insulator film (12, 30, 37).

13. The component according to claim 11,
characterized in that
the flat conductor set is implemented as an FPC (08, 27, 34, 44, 57, 67, 71), whose flat conductor film is particularly equipped with electronic parts.

14. The component according to claim 1,
characterized in that
the insulator element is implemented as an electrically insulating sheath, which encloses the printed conductors on all sides.

15. The component according to claim 14,
characterized in that
the flat conductor set is implemented as an FPC.

16. The component according to claim 1,
characterized in that
the functional element is implemented as a lamp (10, 21, 28, 35), in particular as an LED.

17. The component according to claim 16,
characterized in that
the lamp (28) is situated on a surface of the component (25), particularly facing away from the visible side of the component (25).

18. The component according to claim 17,
characterized in that
the light generated by the lamp (10, 28, 35) is relayed using a light guiding element (31, 40, 42).

19. The component according to claim 18,
characterized in that
the light guiding element (31, 40, 42) extends through the hard foam body (11, 26).

20. The component according to claim 16,
characterized in that
the lamp (35) is situated in the interior of the hard foam body (36), a light guiding element (40) being provided in or on the hard foam body (36), using which the light generated by the lamp (35) is relayed to a light exit opening (39).

21. The component according to claim 16,
characterize in that
the lamp (10) is situated on a cable tail (09) of the flat conductor set (08) projecting from the hard foam body (11).

22. The component according to claim 21,
characterized in that
the cable tail (09) carrying the lamp (10) is fixed on the component (07) after the curing of the hard foam body (11).

23. The component according to claim 22,
characterized in that
the lamp (10) provided on the cable tail (09) is fixed on a concealed surface of the component (07), a light guiding element (42) being provided on the component (07), using which the light generated by the lamp (10) is relayed through the hard foam body to a light exit opening (41).

24. The component according to claim 18,
characterized in that
the light guiding element is implemented as a light guiding prism (22, 31, 40) or an optical fiber (42).

25. The component according to claim 18,
characterized in that
the light guiding element (40) is at least partially embedded in foam in the hard foam body (36).

26. The component according to claim 18,
characterized in that
the light guiding element (42) is fastened subsequently to the hard foam body (11), particularly snapped in.

27. The component according to claim 16,
characterized in that
the lamp (10) is situated on a component (07), in particular on a seat panel, in such a way that the foot space (18) in a vehicle (01) may be illuminated using the lamp (07).

28. The component according to claim 16,
characterized in that
the lamp is situated on a component, in particular on a sunshade, in such a way that a makeup mirror in the vehicle may be illuminated using the lamp.

29. The component according to claim 1,
characterized in that
the functional element is implemented as a heating unit (15).

30. The component according to claim 29,
characterized in that
the heating unit (15) is implemented as a film heater integrated in the flat conductor set (08).

31. The component according to claim 29,
characterized in that
the heating unit (15) is situated on a seat panel (07) in such a way that, using the heating unit (15), the knee area of the passengers (05) on the rear bench seat (06) of a vehicle (01) may be heated.

32. The component according to claim 1,
characterized in that
the functional element is implemented as a sensor (16).

33. The component according to claim 32,
characterized in that
the sensor (16) operates contactlessly and is completely embedded in the hard foam body (11), in particular, the sensor is implemented as a capactive sensor (16).

34. The component according to claim 32,
characterized in that
the sensor (16) is situated on a seat panel (07) in such a way that contact of the seat panel (16) with body parts or objects may be detected using the sensor (16) to form a pinch protector.

35. The component according to claim 32,
characterized in that
the sensor is situated on a seat panel in such a way that the seat occupancy of a vehicle seat may be detected using the sensor.

36. The component according to claim 1,
characterized in that
the functional element is implemented as a switch.

37. The component according to claim 36,
characterized in that
the switch may be actuated contactlessly an is completely embedded in the hard foam body, in particular, the switch is implemented as a capacitive switch.

38. The component according to claim 1,
characterized in that
the functional element is implemented as control and/or regulatory electronics (17, 18), in particular for dimmable activation of a light element, or for temperature regulation of a heating element, or for analyzing the measured signals of a sensor.

39. The component according to claim 1,
characterized in that
an end, in particular a cable tail (10, 47) of the flat conductor (08, 44) is guided out of the hard foam body (11, 45) in a partition plane defined by the parts (48, 49) of a foaming mold (46).

40. The component according to claim 1,
characterized in that
a seal element (56), in particular a seal stopper, is embedded in foam in the outer surface of the hard foam body (60), a recess or depression being sealed by the seal element (56) in a foaming mold (61) during the foaming of the hard form body (60), and the flat conductor set (62) being guided through a bush in the seal element (56) out of the hard foam body (60) in the recess or depression.

41. The component according to claim 40,
characterized in that
the seal element (56) is implemented in two parts.

42. The component according to claim 41,
characterized in that
the two parts (58, 59) of the seal element (56) may be separated from one another along a particularly planar partition line.

43. The component according to claim 40,
characterized in that
the seal element (56) is only partially embedded in foam, the seal element (56) tapering at least slightly toward the embedded part starting from the embedded part.

44. The component according to claim 40,
characterized in that
the seal element (56) has a flange (63) embedded in foam.

45. The component according to claim 40,
characterized in that
a plug (68, 70, 75, 77, 79) is attached to at least one end of the flat conductor set (67, 71), at least one plug element (72, 76, 78, 80) being provided on a plug (68, 70, 75, 77, 79), via which a printed conductor (13) of the flat conductor set (67, 71) may be electrically contacted.

46. The component according to claim 45,
characterized in that
the plug (68, 70, 75, 77, 79) has a rounded outer contour.

47. The component according to claim 45,
characterized in that
the plug (68, 70, 75, 77, 79) is partially embedded in foam in the hard foam body.

48. The component according to claim 47,
characterized in that
the plug (68, 70, 75, 77, 79) has a closed peripheral sealing surface (74, 81), which comes to rest against the interior of a foaming mold to form a sealing line during the foaming of the hard foam body and seals off the mold cavity of the foaming mold.

49. The component according to claim 48,
characterized in that
the closed peripheral sealing surface (74, 81) has a rounded outer contour.

50. The component according to claim 48,
characterized in that
the sealing surface (74, 81) is formed by a special seal element, in particular a separate sealing ring or a molded-on sealing lip or a molded-on sealing bead.

51. The component according to claim 48,
characterized in that
the closed peripheral sealing surface (74, 81) runs in a sealing plane, the plug elements of the plug penetrating through the sealing plane.

52. The component according to claim 51,
characterized in that
the sealing plane formed by the peripheral sealing surface (81) extends diagonally to the external surface of the hard foam body.

53. The component according to claim 45,
characterized in that
the contact surfaces, which may be electrically contacted, of the plug elements (76, 80), extend parallel to the external surface of the hard foam body.

54. The component according to claim 45,
characterized in that
the contact surfaces, which may be electrically contacted, of the plug elements (72) extend perpendicularly to the external surface of the hard foam body.

55. The component according to claim 45,
characterized in that
the contact surfaces, which may be electrically contacted, of the plug elements (78) extend diagonally to the external surface of the hard foam body.

56. The component according to claim 45,
characterized in that
the plug elements (76, 78, 80) are bent in steps.

57. A plug (68, 70, 75, 77, 79) which may be embedded in foam, in particular to produce a component according to claim 45.
